(19) United States
(12) Patent Application Publication
(10) Pub. No.: US 2002/0189598 A1
(43) Pub. Date: Dec. 19, 2002

(54) Exhaust gas recirculation device

(76) Inventors: Werner Remmels, Immenstaad (DE); Peter Mattes, Markdorf (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/149,707

(22) PCT Filed: Dec. 12, 2000
(86) PCT No.: PCT/EP00/12573

(30) Foreign Application Priority Data
Dec. 17, 1999 (DE) 199 60 998.5

(51) Int. Cl. F02M 25/07

(52) U.S. Cl. 123/568.11; 123/568.12

(57) ABSTRACT

The invention relates to a device for recirculating exhaust gas during the operation of multi-cylinder internal combustion engines. The cylinders (2,3) of the internal combustion engine are divided into two groups. The waste gas of one group, preferably of one cylinder (3), can be supplied to the suction line (4) of the internal combustion engine via an exhaust gas recirculation line (7). The exhaust gas recirculation line is controlled by a controllable valve (11) in said recirculation line (7). A non-return valve (10) which is preferably configured as a non-return flap in the exhaust gas collector line (5) of the internal combustion engine automatically closes or opens a passage between two regions of the exhaust gas collector line (5) according to the position of the valve device (11) in the exhaust gas recirculation line (7). The non-return valve (10) can be easily integrated into the exhaust gas collector line (5) without the need for a specific control, even when there is very little room available.

The invention relates to a device for recirculating exhaust gas during the operation of multi-cylinder internal-combustion engines according to the preamble of claim 1.

Exhaust gas recirculation is an effective measure for lowering the nitrogen oxide emissions in the case of internal-combustion engines. A device for recirculating exhaust gas is known, for example, from U.S. Patent Document U.S. Pat. No. 5,517,976. There, the cylinders of a supercharged internal-combustion engine are divided into two groups, the waste gas of one group, preferably of a cylinder, being fed by way of an exhaust gas recirculation line, to the intake line of the internal-combustion engine. The waste gas of the other cylinder group is collected in an exhaust gas collection line and is fed to the turbine of an exhaust gas turbocharger. The exhaust gas recirculation line and the exhaust gas collection line are mutually connected by way of a connection line and a valve device which controls a flow cross-section of the connection line.

An analogous device is also illustrated in German Patent Document DE 39 30 243 A1, where a 3/2-way valve is used for switching off the exhaust gas recirculation when the internal-combustion engine is cold and the load is low. When the exhaust gas recirculation is switched off, the exhaust gas of a cylinder connected with the exhaust gas recirculation line arrives in the exhaust gas collection line connected to the remaining cylinders. This type of a device, which divides the cylinders into two groups, of which one group is provided for the exhaust gas recirculation, presents the problem that an arrangement of a valve device is required in the region of the exhaust gas collection line where installation space is very limited. When the exhaust gas collection line is cooled, the passing of the drive shaft through the water cooling jacket can, in addition, be achieved only at high constructive expenditures.

From U.S. Patent Document U.S. Pat. No. 4,249,382, another device is known which uses a group of exhaust gas cylinders for recirculating exhaust gas. Here, a valve device having two valves is used for controlling the exhaust gas flows. In an embodiment, a non-return valve is used for preventing the entering of combustion air from the air supply line into the exhaust gas recirculation line.

German Patent Document DE 19521573 A1 shows a supercharged internal-combustion engine with an exhaust gas recirculation which contains a non-return flap in the exhaust gas recirculation line and, in addition, a valve for switching off the exhaust gas recirculation. The recirculated exhaust gas is taken from an exhaust gas collection line to which all cylinders of the internal-combustion engine are connected. The disadvantage of this construction is that the exhaust gas composition of the recirculated gas cannot be optimally adjusted because a control with respect to each cylinder for influencing the exhaust gas quality of the recirculated exhaust gas cannot be achieved.

The invention is based on the problem of providing a valve device for the exhaust gas recirculation, which requires low constructive expenditures in the region of the exhaust gas collection line, for internal-combustion engines having two groups of cylinders of which one group (“dispenser cylinders”) provides the exhaust gas for the exhaust gas recirculation.

This object is achieved by means of the characterizing features of claim 1. A non-return valve preferably constructed as a flap with a restoring spring divides the exhaust gas collection pipe into two sections. The integration of a non-return valve with a control in the exhaust gas collection line presents no constructive problems even under limited space conditions. The control of the recirculated exhaust gas flows takes place by means of a controllable valve in the exhaust gas recirculation line. The arrangement of a controllable valve, together with the drive shaft and the servo motor, in the exhaust gas recirculation line, will cause no problem because of the space available there. In this manner, a solution is achieved which is favorable with respect to the constructive expenditures and the cost.

The invention will be explained in detail by means of an illustrated embodiment.

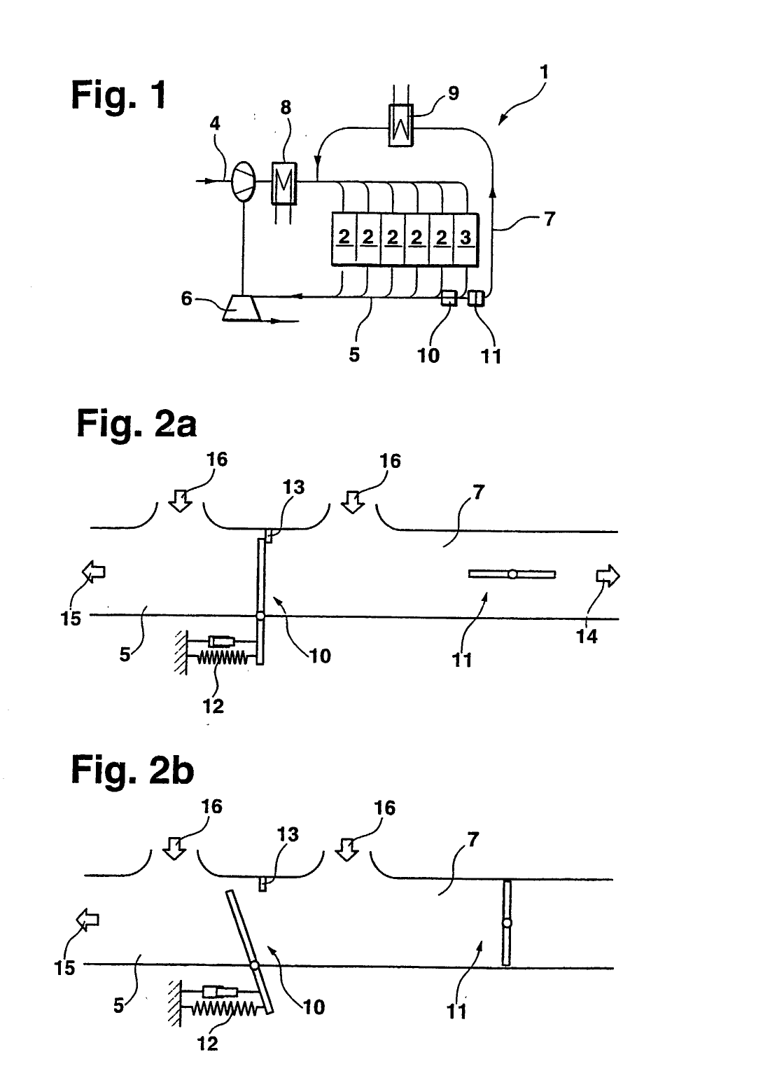

FIG. 1 is a system diagram of an internal-combustion engine with a separate group of cylinders for the exhaust gas recirculation;

FIG. 2a is a view of a section of the exhaust gas line in which a valve device constructed with two flaps is illustrated in the position during the exhaust gas recirculation;

FIG. 2b is a view of a section of the exhaust gas line corresponding to FIG. 2a, the flaps being in the position while the exhaust gas recirculation is switched off.

FIG. 1 is a system diagram of an internal-combustion engine 1 with the line system for combustion air and exhaust gas. The combustion air is supplied to the cylinders 2, 3 of the internal-combustion engine 1 by way of an intake line 4 which contains the compressor 5 of an exhaust gas turbocharger. The exhaust gas of the cylinders 2, 3 is collected in an exhaust gas collection line 5 which contains the turbine 6 of the exhaust gas turbocharger. Furthermore, the exhaust gas collection line 5 has a connection to an exhaust gas recirculation line 7 which is connected with the intake line 4. For cooling the air and exhaust gas flows, heat exchangers 8, 9 may be provided. The exhaust gas recirculation is controlled by valves 10 and 11, which are arranged in the exhaust gas collection line 5 and in the exhaust gas recirculation line 7. The valve 10, which is constructed as a non-return valve and which is situated in the exhaust gas collection line 5 between the connections of the cylinder groups 2 and 3, separates two regions of the exhaust gas collection line 5.

In FIGS. 2a and 2b, the exhaust gas line system is in each case illustrated in the region of the valve device consisting of valves 10 and 11 for recirculating the exhaust gas, in which case, in the position of the valves according to FIG. 2a, a recirculation of the exhaust gas of the cylinder 3 takes place, and in the position of the valves according to FIG. 2b, the exhaust gas recirculation is switched off, so that the exhaust gas of all cylinders 2, 3 reaches the turbine 6.

The valves 10 and 11 are constructed as flaps. The valve 11 arranged in the exhaust gas recirculation line 7 can be switched as a function of engine operating parameters into an opened position for the exhaust gas recirculation (FIG. 2a) and a closed position (FIG. 2b), in which no exhaust gas recirculation takes place. Because of the return stroke function of the valve 10, only the exhaust gas of the cylinder 3 is recirculated.

The valve 10 arranged in the exhaust gas collection line 5, during the exhaust gas recirculation, is held, because of the occurring pressure conditions and as a result of the effect of a restoring spring 12, in a closed position while impacting against an abutment 13, as illustrated in FIG. 2a. The restoring force of the spring is selected such that, in coordination with the existing pressure conditions, the desired opening and closing conditions are met. A damping element, which is applied to the flap, prevents wobbling movements caused by pressure surges. The direction of the exhaust gas flows is indicated by arrows 14, 15 and 16.

When, for switching off the exhaust gas recirculation, the valve 11 is moved into the closed position corresponding to FIG. 2b, the valve 10 automatically opens up because of the pressure difference occurring in the regions of the exhaust gas collection line separated from the valve 10, and a passage is created by way of which the exhaust gas of the cylinder 3 flows over into the section of the exhaust gas collection line connected with the turbine 6. All exhaust gas of all cylinders reaches the turbine 6.

In order to vary the recirculated exhaust gas rate, it is also possible to only partially open the valve 11 in the exhaust gas recirculation line 7, so that only a portion of the exhaust gas of the cylinder 3 (dispenser cylinder) is recirculated into the intake line, while the other portion, together of the exhaust gas of the remaining cylinders 2, arrives at the exhaust gas turbine. The exhaust gas pressure in the exhaust gas recirculation line is, among other things, dependent on the opening of the valve 11. The larger the opening of the valve 11, the lower the exhaust gas pressure in the exhaust gas recirculation line caused because of the back pressure, and the larger the recirculated exhaust gas quantity. The position of the valve 10 depends on the position of the valve 11.

The illustrated valve device consisting of the valves 10 and 11 for the exhaust gas recirculation permits a constructively simple design in the region of the exhaust gas collection line 7, because, as a result of the arrangement of a controllable valve device in the exhaust gas recirculation line 7, only an automatic non-return valve is sufficient in the exhaust gas collection line. The non-return valve constructed as a spring-loaded flap can be represented also in narrow installation conditions without any high-expenditure constructive measures. In the case of a cooled exhaust gas collection line, particularly also the high-expenditure passage of the required drive shaft through the water cooling jacket will be eliminated.

Furthermore, the use of an automatic flap in the exhaust gas collection line has the advantage that it can serve as a safety device in the event that the exhaust gas of the dispenser cylinder can nevertheless flow off, for example, in the case of a defect of the valve 11, in the event of disturbances in the control, when the exhaust gas cooler or other components in the recirculation line are dirty or clogged.

1. Device for recirculating exhaust gas in the case of a multi-cylinder internal-combustion engine, having an intake line for supplying combustion air to the cylinders, and having an exhaust gas collection line for discharging exhaust gas from the cylinders of the internal-combustion line, a valve being provided in the exhaust gas collection line between two regions of the exhaust gas collection line assigned to two groups of cylinder, and a region of the exhaust gas collection line being connectable with an exhaust gas recirculation line which leads into the intake line,
characterized in that the valve (10) arranged in the exhaust gas collection line (5) is an automatic non-return valve which, as a function of the existing pressure difference, permits a flowing over of exhaust gas from the region of the exhaust gas collection line (5) connected with the exhaust gas recirculation line (7) into the other region of the exhaust gas collection line (5) bounded by the valve (10), but prevents a flow in the reverse direction by closing, and in that, in addition, a controllable valve (11) is arranged in the exhaust gas recirculation line (7) which controls a flow cross-section of the exhaust gas recirculation line (7).

2. Device according to claim 1,
characterized in that the non-return valve is constructed as a flap valve which is acted upon by a restoring spring (13) in the closing direction until it impacts on an abutment (13).

3. Device according to claim 1 or 2,
characterized in that the valve (11) controls the flow cross-section in the exhaust gas recirculation line (7) as a function of engine operating parameters.
